(19) United States
(12) Patent Application Publication
(10) Pub. No.: US 2024/0348162 A1
(43) Pub. Date: Oct. 17, 2024

(54) VOLTAGE CONVERTER

(71) Applicant: SAMSUNG ELECTRONICS CO., LTD., Suwon-si (KR)

(72) Inventors: Sanghoon LEE, Suwon-si (KR); Sanghee Kang, Suwon-si (KR); Hobin Yi, Suwon-si (KR); Hocheol Chung, Suwon-si (KR); Woojin Han, Suwon-si (KR)

(73) Assignee: SAMSUNG ELECTRONICS CO., LTD., Suwon-si (KR)

(21) Appl. No.: 18/677,097

(22) Filed: May 29, 2024

(30) Foreign Application Priority Data
Mar. 29, 2023 (KR) 10-2023-0041529
Jun. 29, 2023 (KR) 10-2023-0084532

(51) Int. Cl. H02M 3/07; H02M 1/00; H02M 3/158

(52) U.S. Cl. CPC H02M 3/07; H02M 1/007; H02M 3/158

(57) ABSTRACT

A voltage converter includes: a plurality of switches, a switch controller, a first flying capacitor and a second flying capacitor connected to the first flying capacitor, and a third flying capacitor and a fourth flying capacitor each being connected to an output node. The switch controller controls the plurality of switches to alternately perform a first operation and a second operation in order to allow the voltage source to generate a first input voltage.

### CROSS-REFERENCE TO RELATED APPLICATIONS

This application is based on and claims priority under 35 U.S.C. § 119 to Korean Patent Application Nos. 10-2023-0041529, filed on Mar. 29, 2023, and 10-2023-0084532, filed on Jun. 29, 2023, in the Korean Intellectual Property Office, the disclosures of which are incorporated by reference herein in their entireties.

### BACKGROUND

### 1. Field

The disclosure relates to a voltage converter including a plurality of switches and a flying capacitor.

### 2. Description of Related Art

Electronic devices are configured to generate and utilize various levels of voltage internally. In particular, mobile devices such as smartphones and tablets, which rely on batteries, need to generate a wider range of voltages because the battery generates a limited range of the voltages.

When the mobile device is connected to a charger, the mobile device needs to separately generate a first voltage to charge the battery from external power and a second voltage to be applied to internal components. Additionally, when the mobile device is connected to external mobile devices (such as an on-the-go (OTG) device) that receive power from the mobile device, the mobile device needs to generate, from the battery voltage, a voltage to apply to the external mobile devices.

Since the mobile device is required to generate various voltages, the mobile device needs to include multiple voltage converters, which would cause increased manufacturing costs and large device sizes.

### SUMMARY

Provided is a voltage converter that is configured to operate with high efficiency while occupying a relatively small circuit area.

According to an aspect of the disclosure, a voltage converter includes: a plurality of switches; a first conversion circuit connected to a voltage source, the first conversion circuit including a first flying capacitor and a second flying capacitor connected to the first flying capacitor; a second conversion circuit including a third flying capacitor and a fourth flying capacitor each being connected to an output node, the second conversion circuit being configured to output a charging current through the output node; and a switch controller connected to the first conversion circuit and the second conversion circuit, wherein the switch controller is configured to control the plurality of switches to alternately perform: a first operation that connects the first flying capacitor to the voltage source, connects the third flying capacitor to the first flying capacitor and the second flying capacitor, and connects the second flying capacitor and the fourth flying capacitor to a ground, and a second operation that connects the first flying capacitor and the third flying capacitor to the ground, connects the second flying capacitor to the voltage source, and connects the fourth flying capacitor to the first flying capacitor and the second flying capacitor.

According to an aspect of the disclosure, a voltage conversion circuit includes: a first switch and a second switch that connected in series between a voltage source and a ground; a first flying capacitor connected between the first switch and the second switch; a third switch and a fourth switch that connected in parallel with the first switch and the second switch, the third switch and the fourth switch being between the voltage source and the ground; a second flying capacitor connected between the third switch and the fourth switch; a fifth switch connected between a point between the first switch and the first flying capacitor and a point between the second flying capacitor and the fourth switch; a sixth switch connected between a point between the third switch and the second flying capacitor and a point between the first flying capacitor and the second switch; a seventh switch, an eighth switch, a ninth switch, and a tenth switch connected in series between the ground and a first connection node, the first connection node being between the first flying capacitor and the sixth switch; an eleventh switch, a twelfth switch, a thirteenth switch, and a fourteenth switch connected in series between the ground and a second connection node, the second connection node being between the second flying capacitor and the fifth switch; a third flying capacitor connected between a first node between the seventh switch and the eighth switch and a second node between the ninth switch and the tenth switch; and a fourth flying capacitor connected between a third node between the eleventh switch and the twelfth switch and a fourth node between the thirteenth switch and the fourteenth switch, wherein a charging current is output through an output node that is commonly connected to the eighth switch, the ninth switch, the twelfth switch, and the thirteenth switch, and wherein the output node is between the eighth switch and the ninth switch, and the output node is between the twelfth switch and the thirteenth switch.

According to an aspect of the disclosure, a voltage converter includes: a voltage conversion circuit including a plurality of switches; and a switch controller connected to the voltage conversion circuit, wherein the voltage conversion circuit includes: a first flying capacitor and a second flying capacitor connected to the first flying capacitor; and a third flying capacitor and a fourth flying capacitor each being connected to an output node, wherein the switch controller is configured to control the plurality of switches to alternately perform: a first operation that connects the first flying capacitor to a voltage source, connects the third flying capacitor to the first flying capacitor and the second flying capacitor, and connects the second flying capacitor and the fourth flying capacitor to a ground, and a second operation that connects the first flying capacitor and the third flying capacitor to the ground, connects the second flying capacitor to the voltage source, and connects the fourth flying capacitor to the first flying capacitor and the second flying capacitor, to allow the voltage source to generate a first input voltage.

The voltage converter of the disclosure is configured to operate with high efficiency while occupying a relatively small circuit area.

### BRIEF DESCRIPTION OF DRAWINGS

The above and other objects and features of the disclosure will become apparent by describing in detail embodiments thereof with reference to the accompanying drawings:

FIG. 1 illustrates a voltage converter according to an embodiment of the disclosure;

FIG. 2 illustrates a voltage converter according to an embodiment of the disclosure;

FIG. 3A illustrates a current flow when a switch controller performs a first operation using a voltage conversion circuit of FIG. 2, according to an embodiment of the disclosure;

FIG. 3B illustrates a current flow when the switch controller performs a second operation using the voltage conversion circuit of FIG. 2 according to an embodiment of the disclosure;

FIG. 3C illustrates signals applied from a voltage source to a voltage conversion circuit when the switch controller performs the first operation of FIG. 3A and the second operation of FIG. 3B;

FIG. 4 is a table showing a voltage stress and a current stress applied to elements in each of a conventional voltage converter and a voltage converter according to an embodiment of the disclosure;

FIG. 5 is a table showing types and numbers of elements included in each of a conventional voltage converter and a voltage converter according to an embodiment of the disclosure;

FIG. 6 is a graph showing a charging efficiency of a conventional voltage converter and a voltage converter according to an embodiment of the disclosure;

FIG. 7A illustrates a voltage conversion circuit of FIG. 2 including a plurality of gate drivers according to an embodiment of the disclosure;

FIG. 7B illustrates a second gate driver of FIG. 7A;

FIG. 7C illustrates a third gate driver of FIG. 7A;

FIG. 8 illustrates a voltage converter further including auxiliary switches according to an embodiment of the disclosure;

FIG. 9 illustrates a voltage converter according to an embodiment of the disclosure;

FIG. 10 illustrates a voltage converter according to an embodiment of the disclosure; and

FIG. 11 illustrates a voltage converter according to an embodiment of the disclosure.

### DETAILED DESCRIPTION

Below, embodiments of the disclosure will be described in detail and clearly to such an extent that an ordinary one in the art easily implements the disclosure. The description merely illustrates the principles of the disclosure. Those skilled in the art will be able to devise one or more arrangements that, although not explicitly described herein, embody the principles of the disclosure. Furthermore, all examples recited herein are principally intended expressly to be only for explanatory purposes to help the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass equivalents thereof.

Terms used in the disclosure are used only to describe a specific embodiment, and may not be intended to limit the scope of another embodiment. A singular expression may include a plural expression unless it is clearly meant differently in the context. The terms used herein, including a technical or scientific term, may have the same meaning as generally understood by a person having ordinary knowledge in the technical field described in the present disclosure. Terms defined in a general dictionary among the terms used in the present disclosure may be interpreted with the same or similar meaning as a contextual meaning of related technology, and unless clearly defined in the present disclosure, it is not interpreted in an ideal or excessively formal meaning. In some cases, even terms defined in the disclosure cannot be interpreted to exclude embodiments of the present disclosure.

In one or more embodiments of the disclosure described below, a hardware approach is described as an example. However, since the one or more embodiments of the disclosure include technology that uses both hardware and software, the various embodiments of the present disclosure do not exclude a software-based approach.

In addition, in the disclosure, in order to determine whether a specific condition is satisfied or fulfilled, an expression of more than or less than may be used, but this is only a description for expressing an example, and does not exclude description of more than or equal to or less than or equal to. A condition described as ‘more than or equal to’ may be replaced with ‘more than’, a condition described as ‘less than or equal to’ may be replaced with ‘less than’, and a condition described as ‘more than or equal to and less than’ may be replaced with ‘more than and less than or equal to’.

The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

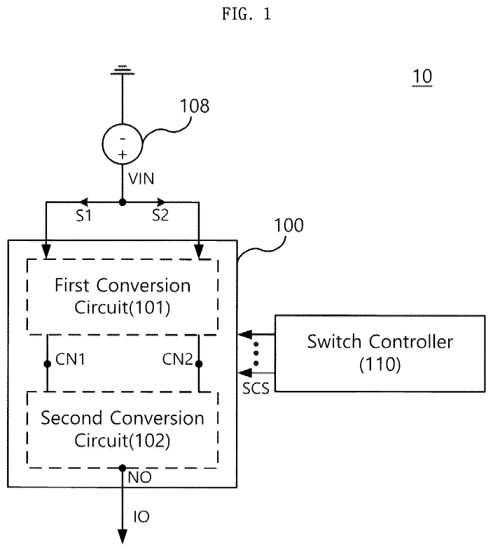

FIG. 1 is a block diagram showing a voltage converter 10 according to an embodiment of the disclosure. Referring to FIG. 1, the voltage converter 10 may include a voltage conversion circuit 100 connected to a voltage source 108 and a switch controller 110. The voltage conversion circuit 100 may receive an input voltage VIN from the voltage source 108 and may output a charging current IO.

In some embodiments, the voltage conversion circuit 100 may include a plurality of switches. The voltage conversion circuit 100 may output the charging current IO based on the input voltage VIN applied thereto from the voltage source 108 through at least some of the switches. To this end, the switch controller 110 may control the switches included in the voltage conversion circuit 100. In some embodiments, the switch controller 110 may control each of the switches included in the voltage conversion circuit 100 in response to (or based on) at least one switch control signal SCS.

The voltage conversion circuit 100 may include a first conversion circuit 101 and a second conversion circuit 102 each including a plurality of switches. As an example, the first conversion circuit 101 and the second conversion circuit 102 may be connected to each other through at least one of a first connection node CN1 and a second connection node CN2.

According to an embodiment, the voltage conversion circuit 100 may be implemented as a single circuit. As an example, the first conversion circuit 101 and the second conversion circuit 102 may be provided integrally with each other. In this case, the voltage conversion circuit 100 may be a single circuit that includes a plurality of switches and a plurality of capacitors, however, the disclosure should not be limited thereto or thereby.

The first conversion circuit 101 may receive the input voltage VIN from the voltage source 108. In some embodiments, the first conversion circuit 101 may receive a first signal S1 and/or a second signal S2 corresponding to the input voltage VIN from the voltage source 108.

As an example, the first signal S1 and the second signal S2 may have substantially the same duty ratio, e.g., about 50%. In addition, the first signal S1 and the second signal S2 may have opposite phases to each other.

The first signal S1 and the second signal S2 may be alternately applied to the voltage conversion circuit 100 (or the first conversion circuit 101). Accordingly, the voltage converter 10 may continuously maintain a constant input voltage VIN (or a constant input current) with respect to the voltage conversion circuit 100. Thus, the voltage converter 10 according to the disclosure may maintain the input voltage VIN for the voltage conversion circuit 100 and thus may improve an efficiency of a voltage conversion operation using the voltage conversion circuit 100.

In addition, the second conversion circuit 102 may output the charging current IO through an output node NO. In some embodiments, the second conversion circuit 102 may output the charging current IO based on a signal applied thereto from the first conversion circuit 101. In this case, the charging current IO may be a current applied to charge an electronic device, system, or battery connected to the voltage converter 10 through the output node NO.

As described above, the voltage converter 10 may control the (plurality of) switches included in the voltage conversion circuit 100 using the switch controller 110 to output the charging current IO.

Accordingly, the voltage converter 10 may receive the input voltage VIN (or the input current) from the voltage source 108 to output the charging current IO.

In addition, the voltage converter 10 may alternately receive the first signal S1 and the second signal S2, which have opposite phases to each other, from the voltage source 108 and may improve an efficiency of the operation to output the charging current IO.

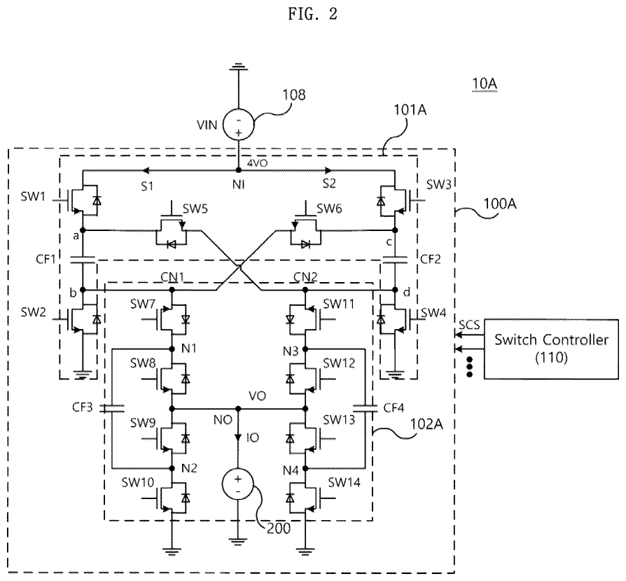

FIG. 2 is a circuit diagram showing a voltage converter 10A according to an embodiment of the disclosure. As an example, the voltage converter 10A and a voltage conversion circuit 100A of FIG. 2 may correspond to the voltage converter 10 and the voltage conversion circuit 100 of FIG. 1, respectively.

Referring to FIG. 2, the voltage conversion circuit 100A may include a plurality of switches SW1 to SW14 and a plurality of flying capacitors CF1 to CF4 connected to the switches.

As an example, each of the switches SW1 to SW14 may be implemented with at least one of a transistor and a diode, however, the disclosure should not be limited thereto or thereby. A first conversion circuit 101A may include a first flying capacitor CF1 and a second flying capacitor CF2 connected to the first flying capacitor CF1. In addition, the first conversion circuit 101A may include a first switch SW1 and a second switch SW2, which are connected to the first flying capacitor CF1.

In some embodiments, the first conversion circuit 101A may include the first switch SW1 connected between a voltage source 108 (or an input node NI) and the first flying capacitor CF1 and the second switch SW2 connected between the first flying capacitor CF1 and a ground.

Further, the first conversion circuit 101A may include a third switch SW3 and a fourth switch SW4, which are connected to the second flying capacitor CF2.

In some embodiments, the first conversion circuit 101A may include the third switch SW3 connected between the voltage source 108 (or the input node NI) and the second flying capacitor CF2 and the fourth switch SW4 connected between the second flying capacitor CF2 and the ground.

In addition, the first conversion circuit 101A may include a fifth switch SW5 connected between a point (“a”) between the first switch SW1 and the first flying capacitor CF1 and a point (“d”) between the second flying capacitor CF2 and the fourth switch SW4.

Further, the first conversion circuit 101A may include a sixth switch SW6 connected between a point (“c”) between the third switch SW3 and the second flying capacitor CF2 and a point (“b”) between the first flying capacitor CF1 and the second switch SW2.

A second conversion circuit 102A may include seventh, eighth, ninth, and tenth switches SW7, SW8, SW9, and SW10 connected in series between a first connection node CN1 and the ground. In this case, a source electrode of the sixth switch SW6 may be connected to a source electrode of the seventh switch SW7 via the first connection node CN1.

In addition, the second conversion circuit 102A may include eleventh, twelfth, thirteenth, and fourteenth switches SW11, SW12, SW13, and SW14 connected in series between a second connection node CN2 and the ground. In this case, a source electrode of the fifth switch SW5 may be connected to a source electrode of the eleventh switch SW11 via the second connection node CN2.

Further, the second conversion circuit 102A may include a third flying capacitor CF3 and a fourth flying capacitor CF4 each being connected to an output node NO. In some embodiments, the third flying capacitor CF3 may be connected between a first node N1 between the seventh switch SW7 and the eighth switch SW8 and a second node N2 between the ninth switch SW9 and the tenth switch SW10. In addition, the fourth flying capacitor CF4 may be connected between a third node N3 between the eleventh switch SW11 and the twelfth switch SW12 and a fourth node N4 between the thirteenth switch SW13 and the fourteenth switch SW14.

The second conversion circuit 102A may output a charging current IO through the output node NO that is commonly connected to the eighth switch SW8, the ninth switch SW9, the twelfth switch SW12 and the thirteenth switch SW13. The output node NO is between the eighth switch SW8 and the ninth switch SW9, and the output node NO is between the twelfth switch SW12 and the thirteenth switch SW13.

In this case, the charging current IO may be a current applied to charge a power device 200 connected to the output node NO. As an example, the power device 200 may be an electronic device, system, or battery connected to the voltage converter 10A, however, the disclosure should not be limited thereto or thereby. As an example, the power device 200 may be a battery of an electronic device or system including the voltage converter 10A. As described above, the voltage conversion circuit 100A may receive an input voltage VIN through the first conversion circuit 101A and may output the charging current IO through the second conversion circuit 102A.

In some embodiments, the voltage conversion circuit 100A may receive a first input voltage 4VO having a predetermined first ratio with respect to a charging voltage VO according to the charging current IO from the voltage source 108. As an example, the voltage conversion circuit 100A may receive the first input voltage 4VO with a voltage value that is four times the charging voltage VO from the voltage source 108.

According to an embodiment, the first conversion circuit 101A and the second conversion circuit 102A may be connected to each other through the first connection node CN1 and the second connection node CN2. Accordingly, a separate element, e.g., a capacitor, provided to connect the first conversion circuit 101A and the second conversion circuit 102A may be omitted from the voltage conversion circuit 100A.

Therefore, in the voltage converter 10A according to the disclosure, the increase of an area of the voltage conversion circuit 100A caused by the capacitor connecting the first conversion circuit 101A and the second conversion circuit 102A may be reduced.

According to an embodiment, the sixth switch SW6 and the seventh switch SW7 may share the source electrode with each other through the first connection node CN1. In addition, the fifth switch SW5 and the eleventh switch SW11 may share the source electrode with each other through the second connection node CN2.

Through this, in the voltage conversion circuit 100A of the voltage converter 10A, an area required for the switches (e.g., switches SW5, SW6, SW7, and SW11) implemented with the transistor may be reduced. Therefore, the area for the voltage conversion circuit 100A may be reduced.

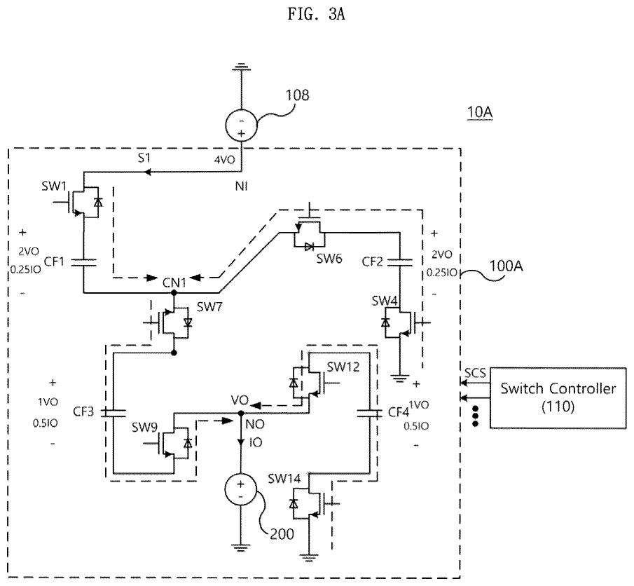

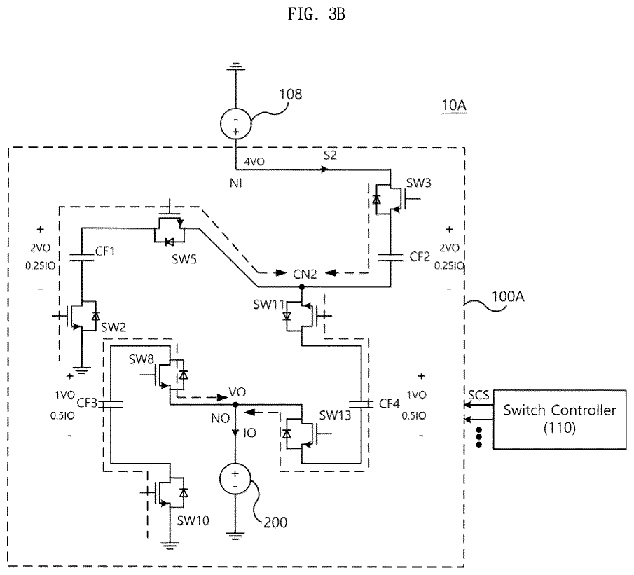

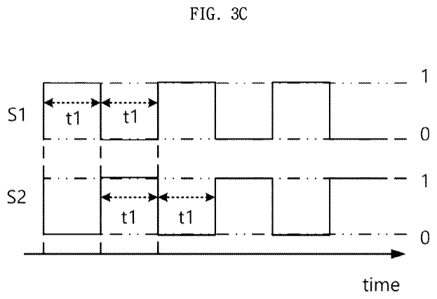

FIG. 3A is a circuit diagram showing a current flow when the switch controller 110 performs a first operation using the voltage conversion circuit 100A of FIG. 2 according to an embodiment of the disclosure. FIG. 3B is a circuit diagram showing a current flow when the switch controller 110 performs a second operation using the voltage conversion circuit 100A of FIG. 2 according to an embodiment of the disclosure. FIG. 3C is a diagram showing signals applied from the voltage source to the voltage conversion circuit 100A when the switch controller 110 performs the first operation of FIG. 3A and the second operation of FIG. 3B.

Referring to FIGS. 3A and 3B, the switch controller 110 may control at least some of the switches SW1 to SW14 included in the voltage conversion circuit 100A. Accordingly, the voltage conversion circuit 100A may output the charging current IO according to the first input voltage 4VO. In some embodiments, the switch controller 110 may perform the first operation and the second operation to control at least some of the switches SW1 to SW14 included in the voltage conversion circuit 100A.

Referring to FIGS. 3A and 3C, the switch controller 110 may perform the first operation that controls at least some of the switches SW1 to SW14 to allow the voltage conversion circuit 100A to output the charging current IO in response to (or based on) the first signal S1. In some embodiments, the switch controller 110 may turn on the first switch SW1 in the first operation and may connect the first flying capacitor CF1 to the voltage source 108 (or the input node NI).

In addition, the switch controller 110 may turn on the seventh switch SW7 and the sixth switch SW6 in the first operation and may connect the third flying capacitor CF3 to the first flying capacitor CF1 and the second flying capacitor CF2. Further, the switch controller 110 may turn on the fourth switch SW4 and the fourteenth switch SW14 in the first operation and may connect the second flying capacitor CF2 and the fourth flying capacitor CF4 to the ground.

That is, the switch controller 110 may perform the first operation that connects the first flying capacitor CF1 to the voltage source 108, connects the third flying capacitor CF3 to the first flying capacitor CF1 and the second flying capacitor CF2, and connects the second flying capacitor CF2 and the fourth flying capacitor CF4 to the ground.

In this case, the switch controller 110 may turn off the second switch SW2, the third switch SW3, the fifth switch SW5, the eighth switch SW8, the tenth switch SW10, the eleventh switch SW11, and the thirteenth switch SW13 in the first operation. Referring to FIGS. 3B and 3C, the switch controller 110 may perform the second operation that controls at least some of the switches SW1 to SW14 to allow the voltage conversion circuit 100A to output the charging current IO in response to (or based on) the second signal S2.

In some embodiments, the switch controller 110 may turn on the third switch SW3 in the second operation and may connect the third flying capacitor CF3 to the voltage source 108 (or the input node NI). In addition, the switch controller 110 may turn on the eleventh switch SW11 and the fifth switch SW5 in the second operation and may connect the fourth flying capacitor CF4 to the first flying capacitor CF1 and the second flying capacitor CF2.

Further, the switch controller 110 may turn on the second switch SW2 and the tenth switch SW10 in the second operation and may connect the first flying capacitor CF1 and the third flying capacitor CF3 to the ground. That is, the switch controller 110 may perform the second operation that connects the second flying capacitor CF2 to the voltage source 108, connects the fourth flying capacitor CF4 to the first flying capacitor CF1 and the second flying capacitor CF2, and connects the first flying capacitor CF1 and the third flying capacitor CF3 to the ground.

In this case, the switch controller 110 may turn off the first switch SW1, the fourth switch SW4, the sixth switch SW6, the seventh switch SW7, the ninth switch SW9, the twelfth switch SW12, and the fourteenth switch SW14 in the second operation.

The switch controller 110 may alternately perform the first operation and the second operation in response to (or based on) the first signal S1 and the second signal S2.

In some embodiments, referring to FIG. 3C, the switch controller 110 may alternately perform the first operation and the second operation in response to (or based on) the first signal S1 and the second signal S2, which have the predetermined duty ratio.

As an example, each of the first signal S1 and the second signal S2 may have the duty ratio of about 50%. Accordingly, each of the first signal S1 and the second signal S2 may alternately hold one (“1”) and zero (“0”) for equal amounts of time ti.

In addition, the first signal S1 and the second signal S2 may have opposite phases to each other. For instance, when the first signal S1 has a value of “1”, the second signal S2 may have a value of “0”.

As an example, the switch controller 110 may perform the first operation in response to (or based on) the first signal S1 with the duty ratio of about 50%. In addition, the switch controller 110 may perform the second operation in response to (or based on) the second signal S2 with the duty ratio of about 50%.

Therefore, the switch controller 110 may alternately perform the first operation and the second operation at the same time intervals in response to (or based on) the first signal S1 and second signal S2, which have the same duty ratio.

Referring to FIGS. 3A to 3C, when the switch controller 110 alternately performs the first operation and the second operation, the first flying capacitor CF1 and the second flying capacitor CF2 may be maintained at a first intermediate voltage 2VO having a level between the charging voltage VO and the first input voltage 4VO. In this case, the voltage source 108 may output the first input voltage 4VO. Accordingly, the input node NI of the voltage conversion circuit 100A may be maintained at the first input voltage 4VO.

Thus, a first intermediate current 0. 25IO that is smaller than the charging current IO may be applied to the first flying capacitor CF1 and the second flying capacitor CF2.

In the case where the switch controller 110 performs the first operation, the first intermediate currents 0. 25IO applied to the first flying capacitor CF1 and the second flying capacitor CF2 may be summed through the first connection node CN1 and may be applied to the third flying capacitor CF3 via the seventh switch SW7.

In the case where the switch controller 110 performs the second operation according to an embodiment, the first intermediate currents 0. 25IO applied to the first flying capacitor CF1 and the second flying capacitor CF2 may be summed through the second connection node CN2 and may be applied to the fourth flying capacitor CF4 via the eleventh switch SW11.

In addition, in the case where the switch controller 110 alternately performs the first operation and the second operation, the third flying capacitor CF3 and the fourth flying capacitor CF4 may be maintained at a second intermediate voltage VO smaller than the first intermediate voltage 2VO.

Thus, a second intermediate current 0. 5IO smaller than the charging current IO and greater than the first intermediate current 0. 25IO may be applied to the third flying capacitor CF3 and the fourth flying capacitor CF4.

The second intermediate currents 0. 5IO applied to the third flying capacitor CF3 and the fourth flying capacitor CF4 may be summed through the output node NO and may be output as the charging current IO.

That is, the switch controller 110 may control at least some of the switches included in the voltage conversion circuit 100A to allow the voltage conversion circuit 100A to receive the first input voltage 4VO that is four times the charging voltage VO from the voltage source 108 and to output the charging current IO.

Therefore, in this case, the voltage converter 10A may be a 4:1 voltage converter that allows the voltage conversion circuit 100A to receive the first input voltage 4VO that is four times the charging voltage VO from the voltage source 108 and to output the charging current IO.

As described above, the voltage converter 10A may maintain a constant intermediate voltage and a constant intermediate current with respect to the switches SW1 to SW14 and/or capacitors CF1 to CF4 included in the voltage conversion circuit 100A. Accordingly, the voltage converter 10A may improve the efficiency of the voltage conversion operation using the voltage conversion circuit 100A.

In addition, the number of switches and the number of capacitors required to implement the voltage conversion circuit 100A of the voltage converter 10A may be reduced. Thus, the area for the voltage conversion circuit 100A of the voltage converter 10A may be reduced.

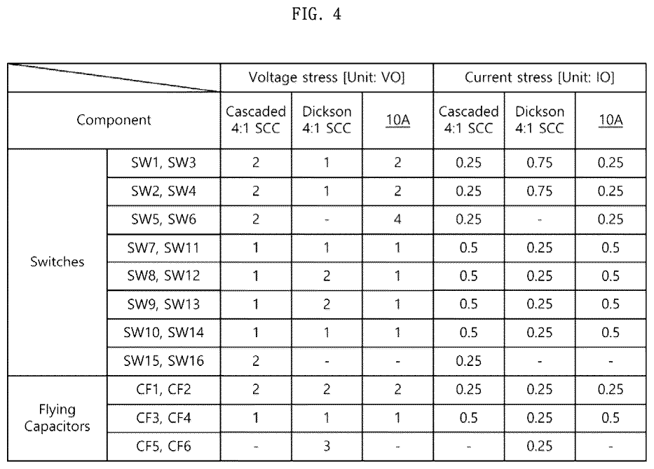

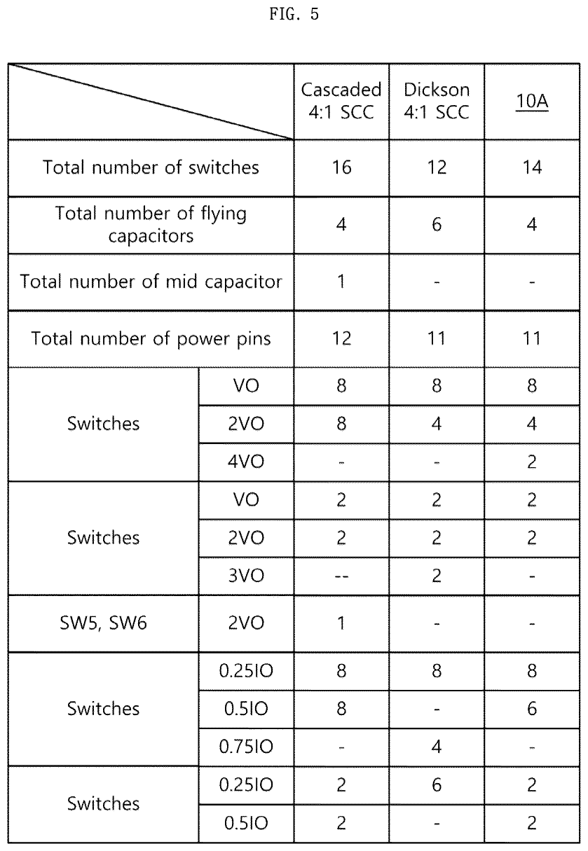

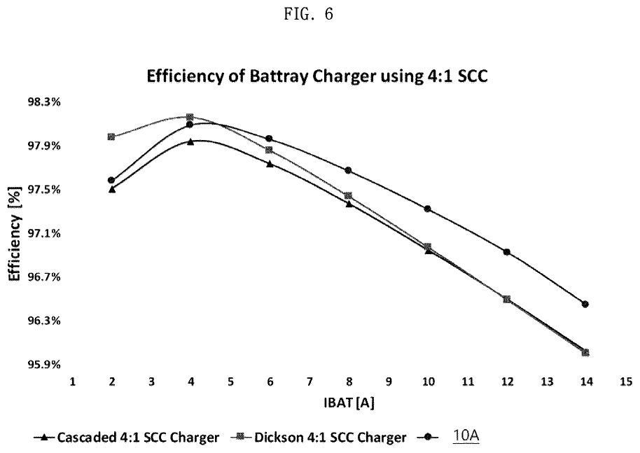

FIG. 4 is a table showing a voltage stress and a current stress applied to elements included in each of a conventional voltage converter and a voltage converter according to an embodiment of the disclosure. FIG. 5 is a table showing types and numbers of elements included in each of a conventional voltage converter and a voltage converter according to an embodiment of the disclosure. FIG. 6 is a graph showing a charging efficiency of a conventional voltage converter and a voltage converter according to an embodiment of the disclosure.

Referring to FIGS. 4, 5, and 6, the voltage converter 10A according to the disclosure may operate with high efficiency while occupying a relatively small circuit area compared to the conventional voltage converter. As an example, the voltage converters 10A shown in FIGS. 4 to 6 may correspond to the voltage converter 10A of FIG. 2.

Referring to FIG. 4, each of the elements included in the voltage converter 10A may have less voltage stress and less current stress than elements included in the conventional voltage converter.

In some embodiments, each of the switches included in the voltage converter 10A may have the voltage stress and the current stress less than those of the elements included in the conventional voltage converter in a turn-off state.

As an example, the eighth switch SW8 included in the voltage converter 10A according to the disclosure may have a voltage stress (e.g., 1VO) that is half a voltage stress (e.g., 2VO) of a switch of a conventional Dickson 4:1 SCC, which corresponds to the eighth switch SW8.

As another example, the first switch SW1 included in the voltage converter 10A according to the disclosure may have a current stress (e.g., 0. 25IO) that is ⅓ times a current stress (e.g., 0/75IO) of a switch of the conventional Dickson 4:1 SCC, which corresponds to the first switch SW1.

As described above, the elements included in the voltage converter 10A according to the disclosure may have relatively less voltage stress compared with the elements included in the conventional voltage converter. Accordingly, the voltage converter 10A according to the disclosure may reduce a power consumed in the voltage conversion operation performed by the voltage conversion circuit 100A.

In addition, the elements included in the voltage converter 10A according to the disclosure may have relatively less current stress compared with the elements included in the conventional voltage converter. Accordingly, the voltage converter 10A according to the disclosure may reduce a conduction loss generated in the voltage conversion operation.

Further, the voltage converter 10A according to the disclosure may reduce a switching loss generated in the voltage conversion operation.

Referring to FIG. 5, the voltage converter 10A according to the disclosure may be implemented with a fewer number of elements compared with the conventional voltage converter.

In some embodiments, the voltage converter 10A may be implemented with a fewer number of switches and capacitors compared with the conventional voltage converter. As an example, the voltage converter 10A may be implemented with fourteen switches, four capacitors, and eleven power pins.

As an example, the voltage converter 10A may be implemented with fourteen switches, which is less than a conventional Cascaded 4:1 SCC that is implemented with sixteen switches. In addition, when compared with the conventional Cascaded 4:1 SCC, the voltage converter 10A may be implemented by omitting a mid-capacitor.

In addition, according to an embodiment, the voltage converter 10A according to the disclosure may be implemented with four capacitors, which is fewer than the conventional Dickson4:1SCC implemented with six capacitors.

Further, according to an embodiment, the voltage converter 10A according to the disclosure may include eleven power pins, which is fewer than the conventional Dickson4:1SCC implemented with twelve power pins.

In addition, referring to FIGS. 4 and 5, the number of switches included in the voltage converter 10A according to the disclosure and each having the first intermediate voltage 2VO is four, which is fewer than eight switches included in the conventional Cascaded 4:1 SCC and each having the first intermediate voltage 2VO.

As described above, the voltage converter 10A according to the disclosure may be implemented with relatively fewer elements and fewer types of elements compared to the conventional voltage converter. Accordingly, the area of the voltage conversion circuit 100A according to the disclosure may be reduced. Thus, the area of the voltage converter 10A including the voltage conversion circuit 100A may be reduced.

Referring to FIG. 6, the voltage converter 10A may operate with a relatively high efficiency compared with the conventional voltage converter. In some embodiments, when outputting the same charging current IBAT, the voltage converter 10A according to the disclosure may operate with the relatively high efficiency compared with the conventional voltage converter.

As an example, in a case where a charging current of about 10 A is output, the conventional Cascaded 4:1 SCC operates with the efficiency of about 96.9%. In addition, in the case where the charging current of about 10 A is output, the conventional Dickson 4:1 SCC operates with the efficiency of about 97.0%. On the other hand, in the case where the charging current of about 10 A is output, the voltage converter 10A according to the disclosure may operate with the efficiency of about 97.4%.

In a case where a charging current of about 12 A is output, the conventional Cascaded 4:1 SCC and the conventional Dickson 4:1 SCC operate with the efficiency of about 96.5%. On the other hand, in the case where the charging current of about 12 A is output, the voltage converter 10A according to the disclosure may operate with the efficiency of about 96. 9%. As described above, the voltage converter 10A according to the disclosure may operate with the relatively high efficiency compared with the conventional voltage converter.

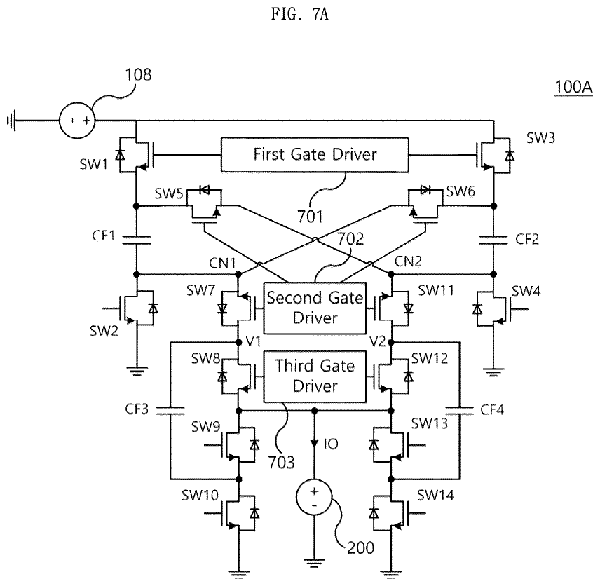

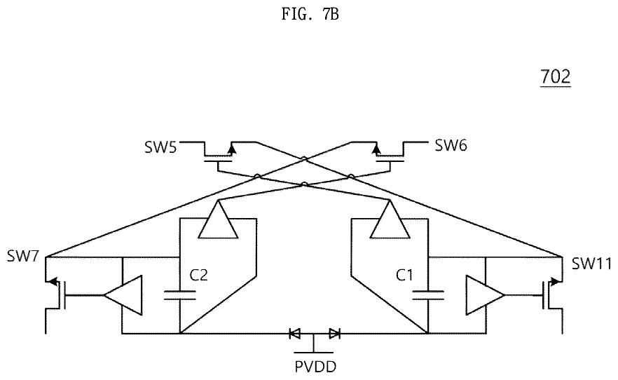

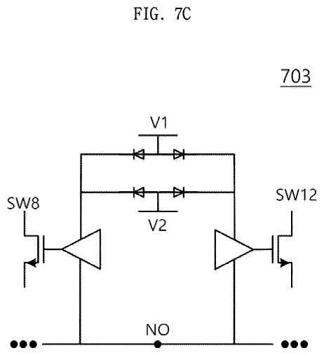

FIG. 7A is a circuit diagram showing the voltage conversion circuit 100A of FIG. 2, which includes a plurality of gate drivers according to an embodiment of the disclosure. FIG. 7B is a circuit diagram showing a second gate driver of FIG. 7A. FIG. 7C is a circuit diagram showing a third gate driver of FIG. 7A. Referring to FIG. 7A, the voltage converter 100A may include a first gate driver 701, the second gate driver 702, and the third gate driver 703.

The voltage conversion circuit 100A may include the first gate driver 701 connected to a gate electrode of the first switch SW1 and a gate electrode of the third switch SW3. In addition, the voltage conversion circuit 100A may include the second gate driver 702 connected to a gate electrode of each of the fifth switch SW5, the sixth switch SW6, the seventh switch SW7, and the eleventh switch SW11. In addition, the voltage conversion circuit 100A may include the third gate driver 703 connected to a gate electrode of the eighth switch SW8 and a gate electrode of the twelfth switch SW12.

In the present embodiment, each of the first gate driver 701, the second gate driver 702, and the third gate driver 703 may be a circuit that applies a gate voltage to a corresponding switch connected thereto to drive the corresponding switch. As an example, the first gate driver 701 may be the circuit that applies the gate voltage to the gate electrode of the first switch SW1 to drive the first switch SW1.

In addition, each of the first gate driver 701, the second gate driver 702, and the third gate driver 703 may be a circuit that applies a voltage to a gate electrode of a corresponding transistor connected thereto based on a voltage applied to a source electrode of the corresponding transistor to drive the corresponding transistor.

Referring to FIGS. 7A and 7B, the second gate driver 702 may include a first capacitor C1 and a second capacitor C2. In some embodiments, the second gate driver 702 may include the first capacitor C1 connected to the source electrode of the fifth switch SW5 and the source electrode of the eleventh switch SW11.

In addition, the second gate driver 702 may include the second capacitor C2 connected to the source electrode of the sixth switch SW6 and the source electrode of the seventh switch SW7. Each of the first capacitor C1 and the second capacitor C2 may be a bootstrap capacitor that applies the gate voltage to each switch based on the voltage applied to the source electrode of each switch to drive each switch implemented with the transistor.

As an example, the first capacitor C1 may be the bootstrap capacitor that applies the gate voltage to the gate electrode of the fifth switch SW5 and the gate electrode of the eleventh switch SW11. In addition, the second capacitor C2 may be the bootstrap capacitor that applies the gate voltage to the gate electrode of the sixth switch SW6 and the gate electrode of the seventh switch SW7.

As described above, the voltage conversion circuit 100A may apply the gate voltage to the plural switches that share the source electrode using a single bootstrap capacitor. Through this, in the voltage converter 10A according to the disclosure, the number of capacitors required for the voltage conversion circuit 100A (or the gate driver) may be reduced.

Therefore, the area of the voltage conversion circuit 100A may be reduced. In addition, in the voltage converter 10A according to the disclosure, the cost needed to implement the voltage conversion circuit 100A may be reduced.

Referring to FIGS. 7A and 7C, the third gate driver 703 may apply one of a first voltage V1 and a second voltage V2 to the gate electrode of the eighth switch SW8 or the gate electrode of the twelfth switch SW12.

In some embodiments, the third gate driver 703 may apply the first voltage V1 to the gate electrode of the twelfth switch SW12 when the switch controller 110 performs the first operation. In addition, the third gate driver 703 may apply the second voltage V2 to the gate electrode of the eighth switch SW8 when the switch controller 110 performs the second operation.

As an example, when the switch controller 110 performs the first operation, a source electrode of the eighth switch SW8 may be connected to the output node NO and may maintain a voltage of VO, and a drain electrode of the eighth switch SW8 may be connected to one end of the third flying capacitor CF3 and may maintain a voltage of 2VO. In this case, the third gate driver 703 may apply the first voltage V1 corresponding to the voltage of 2VO of the one end of the third flying capacitor CF3 to the gate electrode of the twelfth switch SW12.

According to an embodiment, the third gate driver 703 may apply a voltage obtained by subtracting a diode voltage VF from the first voltage V1 (V1−VF), which corresponds to a voltage obtained by subtracting the diode voltage VF from the voltage of 2VO of the one end of the third flying capacitor CF3 (2VO−VF), to the gate electrode of the twelfth switch SW12.

In this case, the third flying capacitor CF3 and the fourth flying capacitor CF4 may be the bootstrap capacitor of the third gate driver 703. In some embodiments, the third flying capacitor CF3 and the fourth flying capacitor CF4 may be the bootstrap capacitor to apply the gate voltage to the gate electrode of the eighth switch SW8 and the gate electrode of the twelfth switch SW12.

In addition, the third flying capacitor CF3 and the fourth flying capacitor CF4 may be the bootstrap capacitor to apply the gate voltage to a gate electrode of the ninth switch SW9 and a gate electrode of the thirteenth switch SW13.

In addition, the switch controller 110 may apply a reference voltage PVDD to a gate electrode of each of the second switch SW2, the fourth switch SW4, the tenth switch SW10, and the fourteenth switch SW14.

As described above, the voltage converter 10A may use the flying capacitor, e.g., CF3 and CF4, as the bootstrap capacitor of the gate driver to drive at least some switches, e.g., SW8, SW12, SW9, and SW13, connected to each flying capacitor. Accordingly, the number of bootstrap capacitors required to form the gate driver of the voltage converter 10 according to the disclosure may be reduced. Therefore, the area of the voltage conversion circuit 100A may be reduced. In addition, in the voltage converter 10A according to the disclosure, the cost needed to implement the voltage conversion circuit 100A may be reduced.

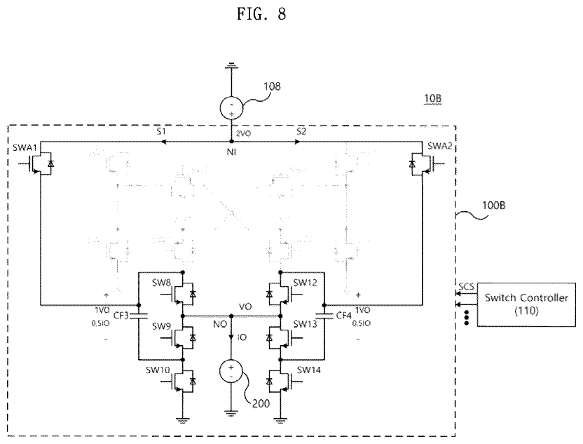

FIG. 8 is a circuit diagram showing a voltage converter 10B that further includes auxiliary switches according to an embodiment of the disclosure. Referring to FIG. 8, a voltage conversion circuit 100B may further include a first auxiliary switch SWA1 and a second auxiliary switch SWA2.

As an example, the voltage conversion circuit 100B shown in FIG. 8 may have substantially the same configuration as the voltage conversion circuit 100A shown in FIG. 2 except the first and second auxiliary switches SWA1 and SWA2. Accordingly, in FIG. 8, the same reference numerals denote the same elements in FIG. 2, and thus, detailed descriptions of the same elements will be omitted.

The voltage conversion circuit 100B may further include the first auxiliary switch SWA1 connected between a voltage source 108 (or an input node NI) and a third flying capacitor CF3 and between the voltage source 108 (or the input node NI) and an eighth switch SW8.

In addition, the voltage conversion circuit 100B may further include the second auxiliary switch SWA2 connected between the voltage source 108 and a fourth flying capacitor CF4 and between the voltage source 108 and a twelfth switch SW12.

A switch controller 110 may control the first auxiliary switch SWA1, the second auxiliary switch SWA2, and at least some of a plurality of switches included in a second conversion circuit to allow the voltage conversion circuit 100B to receive a second input voltage 2VO and to output a charging current IO. In some embodiments, the switch controller 110 may control at least some of the switches included in the voltage conversion circuit 100B to allow the voltage conversion circuit 100B to perform a 2:1 voltage conversion operation that receives the second input voltage 2VO and outputs the charging current IO. In this case, the switch controller 110 may turn off first to seventh switches SW1 to SW7 and an eleventh switch SW11.

The switch controller 110 may perform a third operation that connects the third flying capacitor CF3 to the voltage source 108 and connects the fourth flying capacitor CF4 to a ground. In addition, the switch controller 110 may perform a fourth operation that connects the third flying capacitor CF3 to the ground and connects the fourth flying capacitor CF4 to the voltage source 108.

The switch controller 110 may alternately perform the third operation and the fourth operation. As an example, the switch controller 110 may alternately perform the third operation and the fourth operation in response to (or based on) the first signal S1 and the second signal S2 of FIG. 3C.

In the case where the switch controller 110 alternately performs the third operation and the fourth operation, the third flying capacitor CF3 and the fourth flying capacitor CF4 may be maintained at a second intermediate voltage VO. Accordingly, a second intermediate current 0. 5IO may be applied to the third flying capacitor CF3 and the fourth flying capacitor CF4.

In addition, the second intermediate currents 0. 5IO applied to the third flying capacitor CF3 and the fourth flying capacitor CF4 may be summed through an output node NO and may be output as the charging current IO. That is, the voltage converter 10B may be a 2:1 voltage converter that allows the voltage conversion circuit 100B to receive the second input voltage 2VO that is two times the charging voltage VO from the voltage source 108 and to output the charging current IO.

According to an embodiment, the switch controller 110 may turn off the first auxiliary switch SWA1 and the second auxiliary switch SWA2. In this case, the voltage conversion circuit 100B may have substantially the same configuration as the voltage conversion circuit 100A of FIG. 2. In this case, the voltage converter 10B may be a 4:1 voltage converter that allows the voltage conversion circuit 100B to receive a first input voltage 4VO that is four times the charging voltage VO from the voltage source 108 and to output the charging current 10.

Accordingly, the voltage conversion circuit 100B according to the disclosure may operate as one of a 4:1 voltage conversion circuit and a 2:1 voltage conversion circuit according to the control of the switch controller 110. Therefore, the cost and area required to implement the 2:1 voltage conversion circuit in the voltage converter 10B according to the disclosure may be reduced. In addition, the voltage converter 10B according to the disclosure may reduce the power consumed in the 2:1 voltage conversion operation.

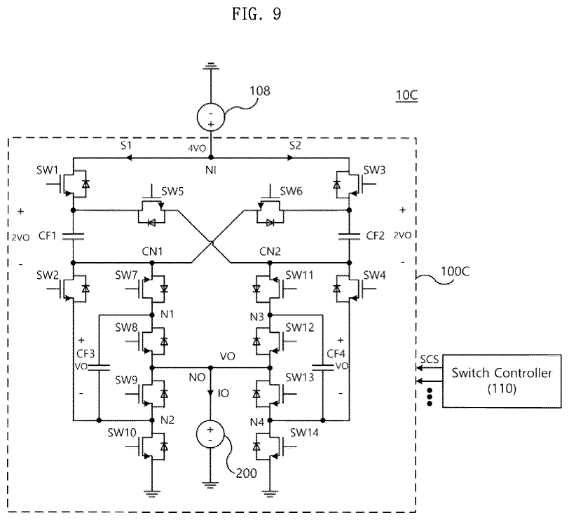

FIG. 9 is a circuit diagram showing a voltage converter 10C according to an embodiment of the disclosure.

Referring to FIG. 9, a voltage conversion circuit 100C may include a second switch SW2 connected to a second node N2 between a ninth switch SW9 and a tenth switch SW10. In this case, a source electrode of the second switch SW2 implemented with a transistor may be connected to a drain electrode of the tenth switch SW10.

In addition, the voltage conversion circuit 100C may include a fourth switch SW4 connected to a fourth node N4 between a thirteenth switch SW13 and a fourteenth switch SW14. In this case, a source electrode of the fourth switch SW4 implemented with a transistor may be connected to a drain electrode of the fourteenth switch SW14.

The voltage conversion circuit 100C shown in FIG. 9 may include substantially the same elements as those of the voltage conversion circuit 100A shown in FIG. 2.

In addition, a switch controller 110 may alternately perform the first and second operations of FIG. 3B on the voltage conversion circuit 100C shown in FIG. 9. Accordingly, redundant descriptions of configurations and operations that are substantially the same as those described above will be omitted.

In the case where the switch controller 110 alternately performs the first operation and the second operation, a first flying capacitor CF1 and a second flying capacitor CF2 may be maintained at a first intermediate voltage 2VO with a level between a charging voltage VO and a first input voltage 4VO.

In this case, a voltage source 108 may output the first input voltage 4VO. Therefore, an input node NI of the voltage conversion circuit 100C may be maintained at a voltage level of the first input voltage 4VO.

In addition, in the case where the switch controller 110 alternately performs the first operation and the second operation, a third flying capacitor CF3 and a fourth flying capacitor CF4 may be maintained at a second intermediate voltage VO smaller than the first intermediate voltage 2VO.

When the second switch SW2 or the fourth switch SW4 is turned off, each of the second switch SW2 and fourth switch SW4 may have a voltage stress corresponding to the second intermediate voltage VO. Accordingly, the voltage conversion circuit 100C according to the disclosure may reduce the voltage stress applied to the second switch SW2 or the fourth switch SW4. As a result, an area of the second switch SW2 and the fourth switch SW4 of the voltage conversion circuit 100C according to the disclosure may be reduced. Thus, an area of the voltage conversion circuit 100C according to the disclosure may be reduced.

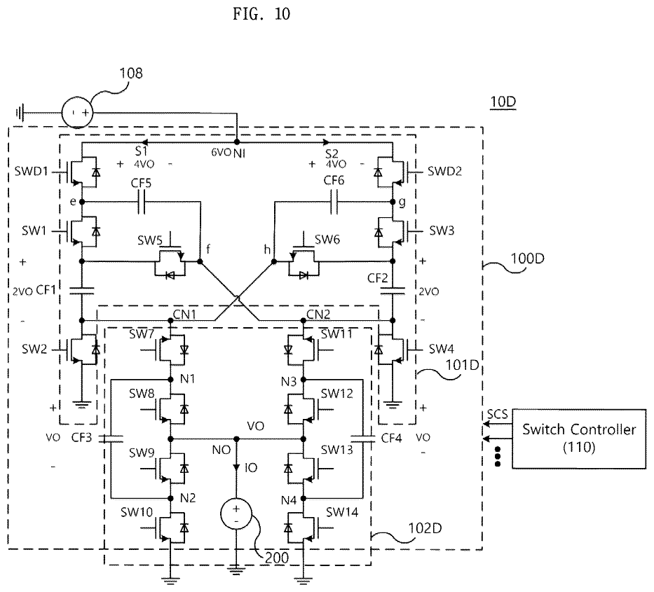

FIG. 10 is a circuit diagram showing a voltage converter 10D according to an embodiment of the disclosure.

Referring to FIG. 10, a voltage conversion circuit 100D may further include a first additional switch SWD1, a second additional switch SWD2, a fifth flying capacitor CF5, and a sixth flying capacitor CF6.

The voltage conversion circuit 100D shown in FIG. 10 may include substantially the same configurations as those of the voltage conversion circuit 100A shown in FIG. 2 except the first additional switch SWD1, the second additional switch SWD2, the fifth flying capacitor CF5, and the sixth flying capacitor CF6. Accordingly, in FIG. 10, the same reference numerals denote the same elements in FIG. 2, and thus, detailed descriptions of the same elements will be omitted.

In some embodiments, the voltage conversion circuit 100D (or a first conversion circuit 101D) may include the first additional switch SWD1 connected between a first switch SW1 and a voltage source 108 and the second additional switch SWD2 connected between a third switch SW3 and the voltage source 108.

In addition, the voltage conversion circuit 100D may further include the fifth flying capacitor CF5 connected between a point (“e”) between the first additional switch SWD1 and the first switch SW1 and a point (“f”) between a fifth switch SW5 and a second connection node CN2.

Further, the voltage conversion circuit 100D may further include the sixth flying capacitor CF6 connected between a point (“g”) between the second additional switch SWD2 and the third switch SW3 and a point (“h”) between a sixth switch SW6 and a first connection node CN1.

A switch controller 110 may control at least some of a plurality of switches included in the voltage conversion circuit 100D to allow the voltage conversion circuit 100D to receive a third input voltage 6VO that is six times a charging voltage VO from the voltage source 108 and to output a charging current IO.

In some embodiments, the switch controller 110 may alternately perform a fifth operation that turns on switches including the first additional switch SWD1 and a sixth operation that turns on switches including the second additional switch SWD2. In this case, the fifth operation and the sixth operation may correspond to the second operation of FIG. 3B and the first operation of FIG. 3A, respectively.

As an example, the switch controller 110 may perform the fifth operation that turns on at least some of the first additional switch SWD1, a second switch SW2, the third switch SW3, the fifth switch SW5, an eighth switch SW8, a tenth switch SW10, an eleventh switch SW11, and a thirteenth switch SW13.

In addition, the switch controller 110 may perform the sixth operation that turns on at least some of the second additional switch SWD2, the first switch SW1, a fourth switch SW4, the sixth switch SW6, a seventh switch SW7, a ninth switch SW9, a twelfth switch SW12, and a fourteenth switch SW14.

The switch controller 110 may alternately perform the fifth operation and the sixth operation. As the switch controller 110 alternately performs the fifth operation and the sixth operation, the fifth flying capacitor CF5 and the sixth flying capacitor CF6 may be maintained at a voltage 4VO having a level that is four times the charging voltage VO.

As described above, the voltage converter 10D may control the voltage source 108 to generate the third input voltage 6VO having a level that is six times the charging voltage VO. In addition, the switch controller 110 may control at least some of the switches included in the voltage conversion circuit 100D to allow the voltage conversion circuit 100D to receive the third input voltage 6VO and to output the charging current IO.

Accordingly, the voltage converter 10D may be a 6:1 voltage converter that allows the voltage conversion circuit 100D to receive the third input voltage 6VO having the level that is six times the charging voltage VO from the voltage source 108 and to output the charging current IO. As described above, the voltage converter 10D according to the disclosure may reduce a cost and an area required to implement a 6:1 voltage conversion circuit.

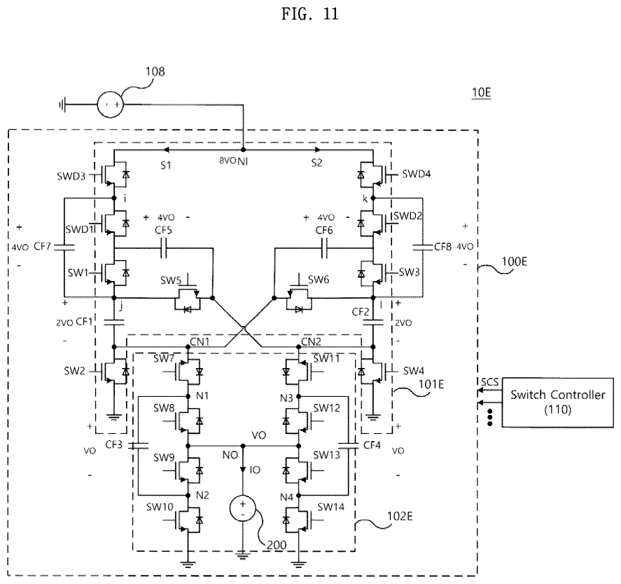

FIG. 11 is a circuit diagram showing a voltage converter 10E according to an embodiment of the disclosure. Referring to FIG. 11, a voltage conversion circuit 100E may further include a third additional switch SWD3, a fourth additional switch SWD4, a seventh flying capacitor CF7, and an eighth flying capacitor CF8.

The voltage conversion circuit 100E shown in FIG. 11 may have substantially the same configuration as the voltage conversion circuit 100D shown in FIG. 10 except the third additional switch SWD3, the fourth additional switch SWD4, the seventh flying capacitor CF7, and the eighth flying capacitor CF8. Accordingly, in FIG. 11, the same reference numerals denote the same elements in FIG. 10, and thus, detailed descriptions of the same elements will be omitted.

In some embodiments, the voltage conversion circuit 100E (or a first conversion circuit 101E) may further include the third additional switch SWD3 connected between a first additional switch SWD1 and a voltage source 108 and the fourth additional switch SWD4 connected between a second additional switch SWD2 and the voltage source 108.

In addition, the voltage conversion circuit 100E may further include the seventh flying capacitor CF7 connected between a point (“i”) between the first additional switch SWD1 and the third additional switch SWD3 and a point (“j”) between a first switch SW1 and a first flying capacitor CF1.

In addition, the voltage conversion circuit 100E may further include the eighth flying capacitor CF8 connected between a point (“k”) between the second additional switch SWD2 and the fourth additional switch SWD4 and a point (“l”) between a third switch SW3 and a second flying capacitor CF2.

A switch controller 110 may control at least some of switches included in the voltage conversion circuit 100E to allow the voltage conversion circuit 100E to receive a fourth input voltage 8VO that is eight times a charging voltage VO from the voltage source 108 and to output a charging current IO.

In some embodiments, the switch controller 110 may alternately perform a seventh operation that turns on switches including the third additional switch SWD3 and an eighth operation that turns on switches including the fourth additional switch SWD4. In this case, the seventh operation and the eighth operation may correspond to the first operation of FIG. 3A and the second operation of FIG. 3B, respectively.

As an example, the switch controller 110 may perform the seventh operation that turns on at least some of the third additional switch SWD3, the second additional switch SWD2, the first switch SW1, a fourth switch SW4, a sixth switch SW6, a seventh switch SW7, a ninth switch SW9, a twelfth switch SW12, and a fourteenth switch SW14.

In addition, the switch controller 110 may perform the eighth operation that turns on at least some of the fourth additional switch SWD4, the first additional switch SWD1, a second switch SW2, the third switch SW3, a fifth switch SW5, an eighth switch SW8, a tenth switch SW10, an eleventh switch SW11, and a thirteenth switch SW13.

The switch controller 110 may alternately perform the seventh operation and the eighth operation. As the switch controller 110 alternately performs the seventh operation and the eighth operation, the seventh flying capacitor CF7 and the eighth flying capacitor CF8 may be maintained at a voltage 4VO having a level that is four times the charging voltage VO.

Therefore, the voltage converter 10E may control the voltage source 108 to generate the fourth input voltage 8VO having a level that is eight times the charging voltage VO. Accordingly, the voltage converter 10E may be an 8:1 voltage converter that allows the voltage conversion circuit 100E to receive the fourth input voltage 8VO having the level that is eight times the charging voltage VO from the voltage source 108 and to output the charging current IO. Through this, the voltage converter 10E according to the disclosure may reduce a cost and an area required to implement an 8:1 voltage conversion circuit.

As described above, in the voltage converter 10 according to the disclosure, the number of switches and the number of capacitors required to implement the voltage conversion circuit 100 may be reduced. In addition, the area of the voltage conversion circuit 100 of the voltage converter 10 may be reduced.

In addition, the voltage converter 10 according to the disclosure may alternately perform different operations to output the charging current using the signals with the same duty ratio. Through this, the voltage converter 10 may maintain the constant intermediate voltage and the constant intermediate current with respect to the elements included in the voltage conversion circuit 100. Accordingly, the voltage converter 10 according to the disclosure may improve the efficiency of the voltage conversion operation by the voltage conversion circuit 100.

The voltage converter 10 according to the disclosure may implement the voltage conversion circuit 100 to allow at least some of the switches implemented with the transistor to share the source electrode in the voltage conversion circuit 100. Through this, in the voltage converter 10, the number of bootstrap capacitors required to implement the gate driver for the switches may be reduced. Accordingly, the area of the voltage conversion circuit 100 including the gate driver may be reduced in the voltage converter 10 according to the disclosure. In addition, the cost consumed in implementing the voltage conversion circuit 100 (or the gate driver) of the voltage converter 10 may be reduced.

In addition, the voltage conversion circuit 100 according to the disclosure may operate as one of the 4:1 voltage conversion circuit and the 2:1 voltage conversion circuit according to the control of the switch controller 110. Through this, the power consumed in the 2:1 voltage conversion operation of the voltage converter 10 according to the disclosure may be reduced.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. A voltage converter comprising:
a plurality of switches;
a first conversion circuit connected to a voltage source, the first conversion circuit comprising a first flying capacitor and a second flying capacitor connected to the first flying capacitor;
a second conversion circuit comprising a third flying capacitor and a fourth flying capacitor each being connected to an output node, the second conversion circuit being configured to output a charging current through the output node; and
a switch controller connected to the first conversion circuit and the second conversion circuit,
wherein the switch controller is configured to control the plurality of switches to alternately perform:
a first operation that connects the first flying capacitor to the voltage source, connects the third flying capacitor to the first flying capacitor and the second flying capacitor, and connects the second flying capacitor and the fourth flying capacitor to a ground, and
a second operation that connects the first flying capacitor and the third flying capacitor to the ground, connects the second flying capacitor to the voltage source, and connects the fourth flying capacitor to the first flying capacitor and the second flying capacitor.

2. The voltage converter of claim 1, wherein, based on the switch controller controlling the plurality of switches to alternately perform the first operation and the second operation, the voltage source is configured to generate a first input voltage having a predetermined first ratio with respect to a charging voltage according to the charging current.

3. The voltage converter of claim 2, wherein the first conversion circuit further comprises:
a first switch connected between the voltage source and the first flying capacitor;
a second switch connected between the first flying capacitor and the ground;
a third switch connected between the voltage source and the second flying capacitor;
a fourth switch connected between the second flying capacitor and the ground;
a fifth switch connected between a point between the first switch and the first flying capacitor and a point between the second flying capacitor and the fourth switch; and
a sixth switch connected between a point between the third switch and the second flying capacitor and a point between the first flying capacitor and the second switch, and
wherein the plurality of switches comprise the first switch, the second switch, the third switch, the fourth switch, the fifth switch, and the sixth switch.

4. The voltage converter of claim 3, wherein the switch controller is further configured to:
in the first operation, turn on the first switch, the fourth switch, and the sixth switch,
in the first operation, turn off the second switch, the third switch, and the fifth switch,
in the second operation, turn on the second switch, the third switch, and the fifth switch, and
in the second operation, turn off the first switch, the fourth switch, and the sixth switch.

5. The voltage converter of claim 3, wherein the first flying capacitor and the second flying capacitor are maintained at a first intermediate voltage having a level between the charging voltage and the first input voltage, and
wherein, based on the switch controller controlling the plurality of switches to alternately perform the first operation and the second operation, a first intermediate current smaller than the charging current is applied to the first flying capacitor and the second flying capacitor.

6. The voltage converter of claim 3, wherein the second conversion circuit further comprises:
a seventh switch, an eighth switch, a ninth switch, and a tenth switch connected in series between the ground and a first connection node, the first connection node being between the first flying capacitor and the sixth switch; and
an eleventh switch, a twelfth switch, a thirteenth switch, and a fourteenth switch connected in series between the ground and a second connection node, the second connection node being between the second flying capacitor and the fifth switch,
wherein the second conversion circuit is further configured to output the charging current through the output node that is commonly connected to the eighth switch, the ninth switch, the twelfth switch, and the thirteenth switch,
wherein the output node is between the eighth switch and the ninth switch, and the output node is between the twelfth switch and the thirteenth switch, and
wherein the plurality of switches comprise the seventh switch, the eighth switch, the ninth switch, the tenth switch, the eleventh switch, the twelfth switch, the thirteenth switch, and the fourteenth switch.

7. The voltage converter of claim 6, wherein the third flying capacitor is connected between a first node, the first node being between the seventh switch and the eighth switch, and a second node, the second node being between the ninth switch and the tenth switch, and
wherein the fourth flying capacitor is connected between a third node, the third node being between the eleventh switch and the twelfth switch, and a fourth node, the fourth node being between the thirteenth switch and the fourteenth switch.

8. The voltage converter of claim 5, wherein the third flying capacitor and the fourth flying capacitor are maintained at a second intermediate voltage having a level, which is smaller than the first intermediate voltage, between the charging voltage and the first input voltage, and
wherein, based on the switch controller controlling the plurality of switches to alternately perform the first operation and the second operation, a second intermediate current, which is greater than the first intermediate current and smaller than the charging current, is applied to the third flying capacitor and the fourth flying capacitor.

9. The voltage converter of claim 6, wherein each of the plurality of switches is implemented with a transistor,
wherein a source electrode of the fifth switch is connected to a source electrode of the eleventh switch, and
wherein a source electrode of the sixth switch is connected to a source electrode of the seventh switch.

10. The voltage converter of claim 9, further comprising:
a first gate driver connected to a gate electrode of each of the first switch and the third switch;
a second gate driver connected to a gate electrode of each of the fifth switch, the sixth switch, the seventh switch, and the eleventh switch; and
a third gate driver connected to a gate electrode of each of the eighth switch and the twelfth switch,
wherein the second gate driver comprises:
a first capacitor configured to apply a gate voltage to the fifth switch and the eleventh switch; and
a second capacitor configured to apply a gate voltage to the sixth switch and the seventh switch.

11. The voltage converter of claim 6, further comprising:
a first auxiliary switch connected between the voltage source and the third flying capacitor, the first auxiliary switch being connected between the voltage source and the eighth switch; and
a second auxiliary switch connected between the voltage source and the fourth flying capacitor, the second auxiliary switch being connected between the voltage source and the twelfth switch,
wherein the switch controller is configured to:
turn off the first switch, the second switch, the third switch, the fourth switch, the fifth switch, the sixth switch, the seventh switch, and the eleventh switch, and
control the first auxiliary switch, the second auxiliary switch, and at least some of the plurality of switches in the second conversion circuit to allow the voltage source to generate the charging voltage and a second input voltage smaller than the first input voltage.

12. The voltage converter of claim 6, wherein the first conversion circuit further comprises:
a first additional switch connected between the first switch and the voltage source;
a second additional switch connected between the third switch and the voltage source;
a fifth flying capacitor connected between a point between the first additional switch and the first switch and a point between the fifth switch and the second connection node; and
a sixth flying capacitor connected between a point between the second additional switch and the third switch and a point between the sixth switch and the first connection node, and
wherein the switch controller is further configured to control the plurality of switches in the first conversion circuit and second conversion circuit to allow the voltage source to generate a third input voltage greater than the first input voltage.

13. The voltage converter of claim 1, wherein the switch controller is further configured to perform the first operation based on a first signal having a predetermined duty ratio and to perform the second operation based on a second signal having the predetermined duty ratio and a phase opposite to the first signal.

14. The voltage converter of claim 2, wherein, based on the switch controller controlling the plurality of switches to alternately perform the first operation and the second operation, a first voltage stress corresponding to the charging voltage is applied to switches that are turned off among a plurality of switches in the second conversion circuit.

15. The voltage converter of claim 1, wherein the first conversion circuit further comprises:
a first switch connected between the voltage source and the first flying capacitor;
a second switch connected between the first flying capacitor and the third flying capacitor;
a third switch connected between the voltage source and the second flying capacitor;
a fourth switch connected between the second flying capacitor and the fourth flying capacitor;
a fifth switch connected between a point between the first switch and the first flying capacitor and a point between the second flying capacitor and the fourth switch; and
a sixth switch connected between a point between the third switch and the second flying capacitor and a point between the first flying capacitor and the second switch.

16. A voltage conversion circuit comprising:
a first switch and a second switch that connected in series between a voltage source and a ground;
a first flying capacitor connected between the first switch and the second switch;
a third switch and a fourth switch that connected in parallel with the first switch and the second switch, the third switch and the fourth switch being between the voltage source and the ground;
a second flying capacitor connected between the third switch and the fourth switch;
a fifth switch connected between a point between the first switch and the first flying capacitor and a point between the second flying capacitor and the fourth switch;
a sixth switch connected between a point between the third switch and the second flying capacitor and a point between the first flying capacitor and the second switch;
a seventh switch, an eighth switch, a ninth switch, and a tenth switch connected in series between the ground and a first connection node, the first connection node being between the first flying capacitor and the sixth switch;
an eleventh switch, a twelfth switch, a thirteenth switch, and a fourteenth switch connected in series between the ground and a second connection node, the second connection node being between the second flying capacitor and the fifth switch;
a third flying capacitor connected between a first node between the seventh switch and the eighth switch and a second node between the ninth switch and the tenth switch; and
a fourth flying capacitor connected between a third node between the eleventh switch and the twelfth switch and a fourth node between the thirteenth switch and the fourteenth switch,
wherein a charging current is output through an output node that is commonly connected to the eighth switch, the ninth switch, the twelfth switch, and the thirteenth switch, and
wherein the output node is between the eighth switch and the ninth switch, and the output node is between the twelfth switch and the thirteenth switch.

17. The voltage conversion circuit of claim 16, further comprising a switch controller connected to a plurality of switches,
wherein the switch controller is configured to control the plurality of switches to alternately perform:
a first operation that connects the first flying capacitor to the voltage source, connects the third flying capacitor to the first flying capacitor and the second flying capacitor, and connects the second flying capacitor and the fourth flying capacitor to the ground, and
a second operation that connects the first flying capacitor and the third flying capacitor to the ground, connects the second flying capacitor to the voltage source, and connects the fourth flying capacitor to the first flying capacitor and the second flying capacitor.

18. The voltage conversion circuit of claim 17, wherein the switch controller is further configured to:
in the first operation, turn on the first switch, the fourth switch, the sixth switch, the seventh switch, the ninth switch, the twelfth switch, and the fourteenth switch,
in the first operation, turn off the second switch, the third switch, the fifth switch, the eighth switch, the tenth switch, the eleventh switch, and the thirteenth switch,
in the second operation, turn on the second switch, the third switch, the fifth switch, the eighth switch, the tenth switch, the eleventh switch, and the thirteenth switch, and
in the second operation, turn off the first switch, the fourth switch, the sixth switch, the seventh switch, the ninth switch, the twelfth switch, and the fourteenth switch.

19. The voltage conversion circuit of claim 17, wherein the switch controller is further configured to control the plurality of switches to perform:
the first operation based on a first signal having a predetermined duty ratio, and
the second operation based on a second signal having the predetermined duty ratio and a phase opposite to the first signal.

20. A voltage converter comprising:
a voltage conversion circuit comprising a plurality of switches; and
a switch controller connected to the voltage conversion circuit,
wherein the voltage conversion circuit comprises:
a first flying capacitor and a second flying capacitor connected to the first flying capacitor; and
a third flying capacitor and a fourth flying capacitor each being connected to an output node,
wherein the switch controller is configured to control the plurality of switches to alternately perform:
a first operation that connects the first flying capacitor to a voltage source, connects the third flying capacitor to the first flying capacitor and the second flying capacitor, and connects the second flying capacitor and the fourth flying capacitor to a ground, and
a second operation that connects the first flying capacitor and the third flying capacitor to the ground, connects the second flying capacitor to the voltage source, and connects the fourth flying capacitor to the first flying capacitor and the second flying capacitor, to allow the voltage source to generate a first input voltage.
